(19) United States
(12) Patent Application Publication
(10) Pub. No.: US 2025/0163844 A1
(43) Pub. Date: May 22, 2025

(54) Cooling System for a Motor Vehicle

(71) Applicant: Bayerische Motoren Werke Aktiengesellschaft, Muenchen (DE)

(72) Inventors: Oeztzan AKIF, Muenchen (DE); Sven BUETOW, Neufahrn bei Freising (DE); Markus SCHUHBAUER, Aschach an der Steyr (AT)

(21) Appl. No.: 18/839,632

(22) PCT Filed: Jun. 26, 2023
(86) PCT No.: PCT/EP2023/067289

§ 371 Date: Aug. 19, 2024

(30) Foreign Application Priority Data
Sep. 20, 2022 (DE) 10 2022 124 112.2

(51) Int. Cl. F01P 11/10; F01P 5/06

(52) U.S. Cl. CPC F01P 11/10; F01P 5/06; F01P 2050/24

(57) ABSTRACT

A cooling system for a motor vehicle includes a cooling module for cooling a drive device of the motor vehicle arranged behind the cooling module in a motor vehicle longitudinal direction, a cooling frame arranged laterally relative to the cooling module in a vehicle width direction, and an air guide arranged laterally relative to the cooling module in the vehicle width direction and extending forwards from the cooling frame in the vehicle longitudinal direction. The air guide has an L-shaped cross-section in an end region facing the cooling frame. The cooling frame has an angled cross-section in an end region facing the air guide for receiving the L-shaped end region of the air guide so that the L-shaped cross-section rests on the inside of the angled cross-section with respect to the vehicle width direction.

### BACKGROUND AND SUMMARY

The present disclosure relates to a cooling system for a motor vehicle, and to a motor vehicle having the cooling system.

A radiator, or a cooling system, for liquid-cooled internal combustion engines of passenger motor vehicles is described in DE 19 68 879 U.

DE 10 2021 102 468 B3 describes an air guide arrangement for a vehicle, having a first air duct and a second air duct. The first air duct has a first hard region having a first fastening portion for fastening the first air duct, and the second air duct has a second hard region having a second fastening portion for fastening the second air duct. The first air duct or the second air duct have an elastic soft region which is in a connecting region of the two air ducts and lies opposite the fastening portion and seals the two air ducts in relation to one another in the connecting region.

DE 37 237 14 C1 describes an air guide housing for a radiator of an internal combustion engine, which consists of a main body, which is fixedly connected to the radiator, and a fan ring which adjoins the latter in the airflow direction and at least partially encloses a fan. An encircling elastic seal, which solely supports the fan ring, is provided between the main body and the fan ring.

DE 40 14 496 C1 describes a fan hood of structural plastics material which is provided between a radiator and an internal combustion engine of a motor vehicle and which is disposed so as to be stationary on the radiator and by way of an annular collar encloses the blades of a fan conveying cooling air. The collar is manufactured by the two-shot molding process so as to be flexible and integral to the fan hood.

DE 82 34 137 Ul describes an air guide device for ventilators on motor vehicle engines, which are disposed opposite a radiator, wherein an air guide hood is fastened on the radiator so as to be coaxial with the ventilator, and a fan ring which is mounted on the engine block is pushed over the ventilator. An elastic cover, which is unilaterally fastened to the hood or the ring, is attached to the annular gap between the hood and the ring.

DE 196 02 186 C1 describes a motor vehicle having a radiator assembly at the front, wherein a duct-type air guide housing is disposed between an end-side air supply opening of an elastic cladding part that forms the vehicle end region and at least one radiator, the air guide housing being connected to the cladding part and the radiator.

DE 10 2020 122 375 A1 describes a motor vehicle comprising a front bumper having at least one air inlet for cooling air, a cooling unit which is provided at a spacing from the bumper, and an air guiding unit which for guiding the cooling air to the cooling unit extends between the bumper and the cooling unit. The air guiding unit has an air guide duct of a flexible material, and connecting elements which are disposed on the air guide duct and by means of which the air guide duct is fastened to the bumper and to the cooling unit in an air-tight manner.

DE 10 2016 123 216 A1 describes a front-end assembly of a motor vehicle, having a front-end module which is fastened to vehicle side members of a body assembly that delimit a motor compartment. At least one cooling device which is mounted in a floating manner is provided on that side of the front-end module that is directed toward the motor compartment. At least one air guide duct which is fastened on the front-end module is provided with at least one air guide arrangement.

DE 10 2007 033 116 A1 describes a front-end module for vehicles, having an assembly support which has a plurality of portions extending in different directions for receiving components of the vehicle. A component which is designed as a cooling module is connected to the assembly support by way of fastening means in a central region of the assembly support. An air guide unit adjoins the assembly support, wherein the air guide unit has at least one air guiding element consisting of an expanded foam material.

However, the requirements set for vehicle components have increased in particular in modern motor vehicles, due to the multiplicity of drive systems, e.g. electric motor with or without internal combustion engine, or vice versa. This also applies to the cooling air guide which must meet the requirements of the different cooling modules.

The requirements of each cooling module in terms of tightness and absence of leakages are substantially identical irrespective of the machine installed; however, there are different load cases for guiding cooling air in terms of a positive pressure or negative pressure occurring in the cooling air guide in different operating states of the motor vehicle, e.g. travel at high/maximum speed, load condition, etc.

In order to guarantee sufficient sealing between the air guide and the cooling module with all existing tolerances in terms of shape and position, the air guide is conventionally equipped with a soft component on the cooling module.

Furthermore, the air guide is conventionally of an ideally soft design for crash reasons, so that the cooling module is ideally not damaged in the event of a frontal crash.

The air guide can inflate in the event of a high positive pressure in the air guide (e.g. while traveling at high speed). Consequently, contact between the cooling module frame, or the radiator frame, and the soft component of the cooling air guide may be lost. In the process, the soft component may be jammed on the cooling module frame and regions of leakages are created. If the soft component is not able to deform reversibly back to the original shape, the leakage, or the regions of leakages, continue(s) to exist.

As a result of the leakage, a hot air roll can be created in the fan-dominated operation (e.g. rapid charging when stationary, driving uphill with a trailer, air condition system is operated with a high output when stationary, etc.). In the process, hot air from the motor compartment is inducted via the leakage between the cooling module frame and the air guide. The temperature of the cooling air ahead of the radiator increases, as a result of which the efficiency of cooling is degraded.

If such an air guide is used in a motor vehicle with an electric motor, in which air for cooling the high-voltage components is also required by the radiator fan in the charging state, these regions of leakages created by traveling at high speed lead to inefficiencies in the cooling output because a hot air roll is created in the motor compartment and warm air from the motor compartment is again inducted as cooling air.

Against the background of this prior art, an object of the present disclosure lies in specifying a device which is suitable to enrich the prior art.

This object is achieved by the features disclosed herein. The present disclosure also contains preferred refinements.

Accordingly, this object is achieved by a cooling system for a motor vehicle.

A cooling system can be understood to mean a radiator, or cooling module, with add-on parts and/or fastening parts for attaching the cooling system to the motor vehicle. The cooling system can be installed in or on a front section of the motor vehicle, in particular in front of a motor compartment.

The cooling system comprises a cooling module for cooling a drive device of the motor vehicle that is disposed in a motor vehicle longitudinal direction behind the cooling module.

The drive device can have an electric motor, an internal combustion engine and/or a fuel cell. A hybrid having an electric motor and an internal combustion engine is also conceivable, for example.

The cooling module can have fins. The cooling module can be referred to as a radiator and/or heat exchanger. The cooling module can cool a liquid by an airflow that impacts the cooling module from the front, the liquid in turn cooling the drive device.

The cooling system furthermore comprises a radiator frame which is disposed in a motor vehicle width direction laterally to the cooling module.

A radiator frame can be understood to mean the at least laterally bordering component of the cooling module. The radiator frame herein can also be additionally disposed above and/or below the cooling module, i.e. be designed in an encircling manner. The explanations hereunder apply in an analogous manner also to potential regions of the radiator frame that are disposed above and below the cooling module.

The cooling system furthermore has an air guide which, proceeding from the radiator frame, extends in the motor vehicle longitudinal direction toward the front and is disposed in the motor vehicle width direction laterally to the cooling module.

The air guide in an end region facing the radiator frame has a L-shaped cross section.

The radiator frame in an end region facing the air guide has an angular cross section for receiving the L-shaped end region of the air guide in such a way that the L-shaped cross section in the motor vehicle width direction rests on the inside of the angular cross section.

It is also conceivable that the L-shaped cross section in the motor vehicle longitudinal direction rests on the front of the angular end region of the radiator frame.

An angular cross section can be understood to be a substantially triangular cross section, i.e. this may also be a radiused corner.

If reference is made herein or hereunder to a cross section, this can relate to a section in a plane on which a motor vehicle height direction is perpendicular. This means a plane which is defined by the motor vehicle longitudinal direction and the motor vehicle height direction.

It is furthermore to be noted that the cooling system can in each case have one right and one left radiator frame and one right and one left air guide, i.e. these components can in each case be disposed once to the left and to the right of the cooling module in the motor vehicle width direction.

The challenges described at the outset can at least be partially overcome by the cooling system described above. In particular, a pressure difference, i.e. a positive pressure in the air guide created when traveling at high speed, e.g. of up to 1500 Pa, in comparison to a negative pressure when stationary, e.g. in a charging procedure, of up to 150 Pa, for example, can be compensated. It is substantially avoided in particular that warm air can be inducted from the motor compartment when stationary. While traveling at high speed, the deformation of the air guide in the region of the L-shaped cross section is reduced due to the labyrinth between the radiator frame and the air guide.

The cooling system described above will be explained in detail hereunder with reference to optional refinements.

The air guide can have a hard component and a soft component, wherein the soft component is disposed in, or forms, the end region of the air guide having the L-shaped cross section that faces the radiator frame.

This end region can also be referred to as the rear end region because this end, or this end region, faces a vehicle interior of the motor vehicle.

The terms “hard” and “soft” may be understood to be mutually relative. The hard component can have a greater stiffness than the soft component.

The hard component, proceeding from the L-shaped end region of the air guide, can extend in the motor vehicle longitudinal direction toward the front

The air guide in an end region facing away from the radiator frame can have a further L-shaped cross section, wherein a further soft component is disposed in, or forms, the end region of the air guide having the further L-shaped cross section that faces away from the radiator frame.

In other words, the air guide can have a U-shaped cross section, wherein a hard component can form the part of the U-shape that extends in the motor vehicle longitudinal direction, and the two legs of the U-shape that extend substantially in the motor vehicle width direction can in each case be implemented by a soft component.

The angular end region of the radiator frame can have a T-shaped cross section.

An angle between a part of the T-shaped cross section that extends in the motor vehicle longitudinal direction and a part of the T-shaped cross section that extends in the motor vehicle width direction on the side that faces away from the L-shaped end region of the air guide can be smaller than 90°.

The cooling system can have a fan which is disposed in the motor vehicle longitudinal direction behind the cooling module and is designed to induct an air mass flow.

The fan can be disposed in the motor vehicle longitudinal direction between the cooling module and the drive device.

The air guide can be disposed in such a way that the air mass flow inducted by the fan is directed from an air inlet in a front of the motor vehicle to the cooling module.

Furthermore provided is a motor vehicle, wherein the motor vehicle has a cooling system described above.

The motor vehicle can be a passenger motor vehicle such as an automobile, for example, and/or a motor truck.

The motor vehicle can have an electric motor which is disposed in the motor vehicle longitudinal direction behind the cooling system, and/or an internal combustion engine which is disposed in the motor vehicle longitudinal direction behind the cooling system, as a drive device.

The above description with reference to the cooling system also applies in an analogous manner to the motor vehicle, and vice versa.

An embodiment will be described hereunder with reference to FIGS. 1 to 3.

### BRIEF DESCRIPTION OF THE DRAWINGS

FIG. 1 schematically shows a perspective view of a cooling system of a motor vehicle;

FIG. 2 schematically shows a view from above onto part of the cooling system from FIG. 1 for the purpose of explaining a state of a cooling air guide of the cooling system when traveling at high speed; and

FIG. 3 schematically shows a view from above onto part of the cooling system from FIG. 1 for the purpose of explaining a state of the cooling air guide of the cooling system when air is inducted through the cooling air guide when stationary.

### DETAILED DESCRIPTION OF THE DRAWINGS

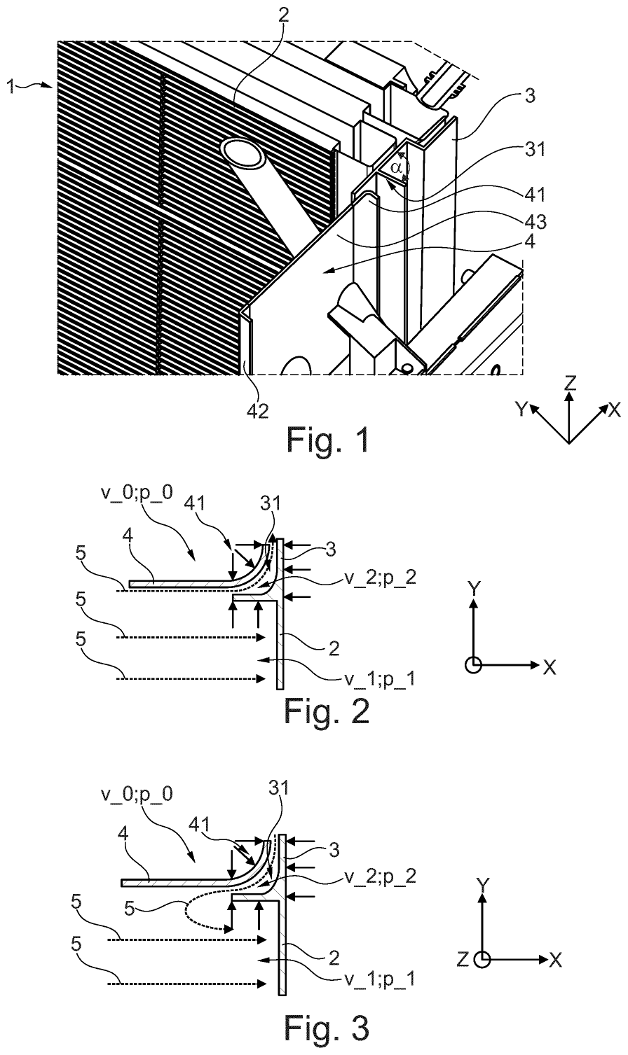

A Cartesian coordinate system is in each case illustrated in FIGS. 1 to 3. The coordinate system comprises a X-axis, a Y-axis and a Z-axis, which in each case enclose a mutual angle of 90°. The X-axis herein corresponds to a motor vehicle longitudinal direction, the Y-axis corresponds to a motor vehicle width direction, and the Z-axis corresponds to a motor vehicle height direction. The motor vehicle longitudinal direction runs from a front to a rear of the motor vehicle not further illustrated in FIGS. 1 to 3, i.e. counter to a main direction of travel of the motor vehicle.

Shown in FIG. 1 is a cooling system 1 for the motor vehicle, in a perspective view, wherein the cooling system 1 comprises a cooling module 2 for cooling a drive device of the motor vehicle (not illustrated) which is disposed in the motor vehicle longitudinal direction X behind the cooling module 2.

The motor vehicle can have an electric motor which is disposed in the motor vehicle longitudinal direction X behind the cooling system 1, and/or an internal combustion engine which is disposed in the motor vehicle longitudinal direction X behind the cooling system 1, as a drive device.

The cooling system 1 moreover has two radiator frames 3 which are disposed in the motor vehicle width direction Y laterally to the cooling module 2 (i.e. to the left and the right of the latter), and two air guides 4 which, proceeding from the respective radiator frame 3, extend in the motor vehicle longitudinal direction X toward the front and are disposed in the motor vehicle width direction Y laterally to the cooling module 2 (i.e. to the left and the right of the latter).

The air guide 4 in an end region facing the radiator frame 3 has a L-shaped cross section 41, and in an end region facing away from the radiator frame 3 has a L-shaped cross section 42, the L-shaped cross sections 41, 42 being connected by way of a central portion 43 which runs parallel to the motor vehicle longitudinal direction X.

Having the L-shaped profile in the soft component, the soft component does not have to be slit in the corners, the stability of the soft component and thus the leakage/hot air roll being reduced as a result. Slitting in the corners was necessary in the case of the conventional profile of the soft component due to forced demolding in the tool. The demolding capability of the soft component in the “L-shape” is provided by a simple open-and-shut tool.

The radiator frame 3 in an end region facing the air guide 4 has an angular cross section 31 for receiving the L-shaped end region of the air guide 4 in such a way that the L-shaped cross section 41 in the motor vehicle width direction Y rests on the inside. It is conceivable that the L-shaped cross section 41 in the motor vehicle width direction Y also rests on the front of the angular end region 31 of the radiator frame 3.

The air guide 4 has a hard component and a soft component. The soft component forms the end region of the air guide 4 having the L-shaped cross section 41 that faces the radiator frame 3, and the end region of the air guide 4 having the L-shaped cross section 42 that faces away from the radiator frame 3. The central portion (or the connecting portion) 43 is formed by the hard component. In this way, the hard component extends between the L-shaped end regions 41, 42 of the air guide 4.

As is derived from FIG. 1, the angular end region 31 of the radiator frame 3 has a T-shaped cross section, wherein an angle α between a part of the T-shaped cross section that extends in the motor vehicle longitudinal direction X and a part of the T-shaped cross section that extends in the motor vehicle width direction Y on the side that faces away from the L-shaped end region of the air guide is smaller than 90°. This offers the advantage that the air guide 4 in the event of a crash at slow speed, e.g. less than 16 km/h, slides past the radiator frame 3, damage thus being able to be prevented.

Furthermore, the cooling system 1 has a fan (not illustrated) which is disposed in the motor vehicle longitudinal direction X behind the cooling module 2 and is designed to induct an air mass flow 5.

The air mass flow 5 is in each case illustrated by arrows in FIGS. 2 and 3. As is derived from FIG. 3, the air guide 4 is disposed in such a way that the air mass flow 5 inducted by the fan is directed from an air inlet in a front of the motor vehicle 1 to the cooling module 2. As is derived from FIG. 2, the same applies to the air mass flow 5 which enters through the air inlet at a high velocity.

The above-described profile of the air guide 4 offers the advantage that the air guide 4 after traveling at high speed returns to its original position because the soft component in the end region 41 is curved outward and no irreversible excessive kink in the soft component is thus formed. In the loaded state, the soft component is pressed onto the radiator frame 3 via the negative pressure of up to 150 Pa, the leakage thus being reduced.

More specifically, it applies when traveling at high speed that p_2<p_0 and p_2<p_1, so that a back pressure is created (cf. FIG. 2). However, v_0<v_1<v_2 and p_2<p_1<p_0 applies if the motor vehicle is stationary when the fan is largely responsible for the air mass flow 5 (FIG. 3).

The air guide 4 is also inflated at high speeds with the profile described herein (cf. FIG. 2). In the process, air flows at a high velocity along the cooling module 3 between the soft component in the end region 41 and the sealing face 31. The high flow velocity as a result of the tight crescent-shaped leakage cross section causes a negative pressure which attracts the soft component in the end region 41 of the air guide 4 toward the sealing face 31 of the radiator frame 3. A negative pressure which attracts the soft component in the end region 41 of the air guide 4 toward the sealing face 31 of the radiator frame 3 is also created in the fan-dominated operation (cf. FIG. 3).

Therefore, the interface between the soft component of the air guide 4 and the radiator frame 3, and the geometric design thereof, can be optimized by the construction described above in such a way that the interaction between positive pressure when traveling at Vmax and negative pressure in the loaded state is counteracted. An irreversible deformation of the soft component is substantially avoided so as to enable the required tightness for each operating load case at all times, while taking into account the absence of damage to the radiator.

### LIST OF REFERENCE SIGNS

1 Cooling system
2 Cooling module
3 Radiator frame
31 Angular cross section of the radiator frame acting as sealing face
4 Air guide
41 Front L-shaped cross section
42 Rear L-shaped cross section
43 Connecting portion
5 Air mass flow
X Motor vehicle longitudinal direction
Y Motor vehicle width direction
Z Motor vehicle height direction

1-10. (canceled)

11. A cooling system for a motor vehicle comprising:
a cooling module configured to cool a drive device of the motor vehicle that is disposed in a motor vehicle longitudinal direction behind the cooling module;
a radiator frame that, in a motor vehicle width direction, is disposed laterally to the cooling module; and
an air guide that, proceeding from the radiator frame, extends in the motor vehicle longitudinal direction toward a front and is disposed in the motor vehicle width direction laterally to the cooling module,
wherein the air guide, in an end region facing the radiator frame, has a L-shaped cross section, and
wherein the radiator frame, in an end region facing the air guide, has an angular cross section for receiving the L-shaped end region of the air guide so that the L-shaped cross section in the motor vehicle width direction rests on an inside of the angular cross section.

12. The cooling system according to claim 11, wherein the air guide has a hard component and a soft component, wherein the soft component is disposed in, or forms, the end region of the air guide having the L-shaped cross section that faces the radiator frame.

13. The cooling system according to claim 12, wherein the hard component, proceeding from the L-shaped end region of the air guide, extends in the motor vehicle longitudinal direction toward the front.

14. The cooling system according to claim 12, wherein the air guide, in an end region facing away from the radiator frame, has a further L-shaped cross section, wherein a further soft component is disposed in, or forms, the end region of the air guide having the further L-shaped cross section that faces away from the radiator frame.

15. The cooling system according to claim 11, wherein the angular end region of the radiator frame has a T-shaped cross section.

16. The cooling system according to claim 15, wherein an angle (a) between a part of the T-shaped cross section that extends in the motor vehicle longitudinal direction and a part of the T-shaped cross section that extends in the motor vehicle width direction, on a side that faces away from the L-shaped end region of the air guide, is smaller than 90°.

17. The cooling system according to claim 11, wherein the cooling system has a fan disposed in the motor vehicle longitudinal direction behind the cooling module and that is designed to induct an air mass flow.

18. The cooling system according to claim 17, wherein the air guide is disposed so that the air mass flow inducted by the fan is directed from an air inlet in a front of the motor vehicle to the cooling module.

19. A motor vehicle, comprising:
the cooling system according to claim 11.

20. The motor vehicle according to claim 19, comprising, as a drive device:
an electric motor that is disposed in the motor vehicle longitudinal direction behind the cooling system, and/or
an internal combustion engine that is disposed in the motor vehicle longitudinal direction behind the cooling system.
